(19) United States
(12) Patent Application Publication
(10) Pub. No.: US 2012/0148815 A1
(43) Pub. Date: Jun. 14, 2012

(54) TEXTILE CORE HAVING CONTINUOUS GLASS FIBERS

(76) Inventor: Gilbert Chomarat, Cologny (CH)

(21) Appl. No.: 13/391,101

(22) PCT Filed: Aug. 11, 2010
(86) PCT No.: PCT/IB10/53635

§ 371 Date: Feb. 17, 2012

(30) Foreign Application Priority Data
Aug. 21, 2009 (FR) 09 04029

(51) Int. Cl. B32B 17/02; B32B 37/06; B32B 5/06

(52) U.S. Cl. 428/219; 442/390; 442/54; 442/334; 442/335; 156/148

(57) ABSTRACT

A core includes a thick, well-ventilated inner layer (2) made of fragmented slivers of continuous glass fibers (2a), the inner layer (2) being covered with two outer layers (3, 4) that consist of fiber segments having a hot-melt surface. The assembly is secured by penetrating fiber segments (3b, 4b) having a hot-melt surface, the segments penetrating, along part of the length thereof, into the inner layer (2) and adhering to the continuous glass fibers (2a).

### TECHNICAL FIELD OF THE INVENTION

The present invention relates to coherent and flexible textile armatures used as reinforcing products for composite items, i.e. for items based on (polyester or others) resin reinforced with reinforcing fibers.

Numerous coherent textile armature reinforcing structures made of one or more layers of fibers coupled together are already known. The textile armature generally takes the form of a flexible lap packaged in a reel, that can thus be transported and handled at the site on which it is used in order to produce a composite item.

In order to produce a composite item, the procedure is generally as follows: a piece of textile armature of suitable surface area is cut out and placed in a mold, and a resin is then introduced into the mold to enclose the textile armature. After polymerization, the resin and the insert form a structure that is mechanically strong.

The mechanical strength properties are obtained only provided that the resin perfectly penetrates between the fibers that make up the insert, without leaving any regions that are free of resin, and on the proviso that it adheres perfectly to the fibers. It is also necessary for the fibers to occupy a sufficient volume and to occupy uniformly the volume of the composite item that is to be produced, notably by conforming to the shape of the item when the item is not planar.

It is finally necessary for the fibers themselves to have enough mechanical strength that they can form an effective reinforcing insert.

Various reinforcing textile armature structures have already been proposed.

Thus, document EP 0 395 548 describes the use of two layers of textile armature, for example made of fiberglass, positioned one on each side of a central layer made of a lap based on synthetic fibers with a permanent crimp, for example polyester fibers 40 to 70 mm long which have undergone a texturizing treatment. The layers of textile armature are coupled to the central layer by stitching/knitting.

Document EP 0 694 643 describes the use of two textile reinforcing layers positioned one on each side of a central layer that provides said material with thickness, the layers being coupled to one another by stitching/knitting, and a bonded or stitched-on web of synthetic fibers is provided against one of the external faces.

Stitching/knitting techniques are relatively slow and the textile armatures thus produced have non-uniform deformability and present defects of appearance at their surface.

In order to increase production rates and reduce the defects that result from a knitting operation, WO 2008/139423 A1 has recently proposed the production of a fiber-based textile armature comprising a thick and aerated internal layer based on 90 mm portions of synthetic fibers which have undergone a treatment that gives them a permanent crimp, and external layers positioned one on each side of the internal layer and comprising portions of fibers with hot melt surface, at least some of the portions of fiber with hot melt surface over part of their length penetrating the internal layer and adhering partially to one another and to the synthetic fibers of the internal layer.

The benefit of this structure is that it gives the textile armatures a great deal of flexibility and good deformability so that they can conform to the shapes of complex molds, the crimped synthetic fibers ensuring that the internal layer maintains sufficient volume for correct penetration of the resin during the subsequent molding operation.

It is possible to introduce 50 mm chopped glass fibers into the external layers. For certain applications it is, however, desirable to obtain a further improvement in the mechanical properties of the composite item, notably its yield or bending strength.

According to another known technique, described in document WO 98/42495 A1, a molding reinforcing product is produced from continuous glass strands bound together by a polymerized binder.

Such reinforcing products involving continuous glass strands can be used to produce composite products using injection molding.

A collection of individual glass filaments, generally of a diameter of 5 μm to 24 μm is known as a strand. A strand generally comprises of the order of 40 filaments. A collection of strands is known as a roving. A roving generally contains around 50 strands.

To allow injection molding, it is desirable to use a reinforcing product that is sufficiently aerated, and in particular that has or maintains enough loft for a given weight of strand.

Document WO 98/42495 A1 teaches a reinforcing product formed of layers of continuous strands taken from a reel, or “roving”. The roving is a wound roving assembly made up of basic strands which are more or less stuck together about the axis of the reel. In that document, the strands from the roving are expanded by air jets or nip rolls then laid randomly in the form of a lap on a support, at the same time as a polymerizable liquid binder is sprayed on.

The disadvantage with this technique is still the necessary presence of a binder to provide the reinforcing product with cohesion while it is being handled prior to the injection-molding step. The result of this is that the amount of glass fibers remains relatively low and the binder is liable to reduce the ability of the resin to penetrate during the injection-molding step.

Furthermore, this known technique is designed for producing a sheet of finite dimensions, and is not suitable, for example, for the continuous production of elements that can easily be cut to a chosen shape.

### SUMMARY OF THE INVENTION

The problem addressed by the present invention is that of appreciably improving the mechanical strength of the composite items produced from fiber-based molding reinforcements while at the same time maintaining the coherence, flexibility and deformability properties displayed by the molding reinforcements prior to molding, and ensuring that the molding reinforcements maintain a satisfactory volume and maintain good properties regarding the penetration and impression of the resin at the time of molding.

In addition, the invention proposes to improve, where necessary, the uniformity of the surface of the composite items produced by molding from the molding reinforcements.

Preferably, the invention also seeks to allow the production of reinforcing products as a continuous strip, that can be packaged as a reel, and that can be cut or chopped without the risk of the edges becoming damaged or frayed.

In order to achieve these objectives and others, the invention proposes a molding reinforcement made of a fiber-based lap, comprising:

a thick and aerated fiber-based internal layer, external layers positioned on each side of the internal layer,

the external layers comprising portions of fibers with hot melt surface,

at least some of the portions of fibers with hot melt surface penetrating the internal layer over part of their length and adhering partially to one another and to the fibers of the internal layer,

and in which the internal layer comprises fibers of the continuous glass strand type which run in random orientations and in several thicknesses.

The continuous nature of the glass strands, laid in random orientations and in several thicknesses, uses their elasticity to good effect to give the internal layer a sufficiently thick and aerated nature that encourages the resin to penetrate at the time of molding.

The continuous glass strands of the internal layer thus make it possible to significantly improve the mechanical properties of the composite items produced by molding such a reinforcement. The external layers, some of the portions of fibers of which penetrate and adhere to the fibers of the internal layer, temporarily hold the continuous glass strands of the internal layer together firmly enough after the molding reinforcement has been manufactured but before it is used.

At the same time, the external layers with penetrating and adhering fibers allow the continuous glass strands to be held together with only a small quantity of material other than glass, i.e. while maximizing the relative proportion of glass in the molding reinforcement.

The external layers can be particularly thin, in the form of a web of fibers, for example as a grammage around 25 to 30 g/m².

In order to benefit from the elastic effect of the glass strands in the internal layer, it is important that these strands form loops and interlacings, so that most of the glass strands each bear against other strands of an adjacent thickness over several portions of their length, the intermediate portions between these points of contact remaining free and elastically flexible, giving the internal layer the ability to be compressed elastically. This effect can naturally be obtained with long strands, for example strands over 1 meter long. However, it has been found that this effect is still obtained surprisingly with strands chopped to shorter lengths, for example of between around 20 and 40 cm long.

In the description and the claims, the glass strands are therefore considered to be “continuous” when they are in excess of around 20 cm long.

In a first embodiment, the continuous glass strands are portions of strands of a length greater than around 20 cm.

The advantage of 20 to 40 cm strands is greater ease of use in the step of laying them on a web of synthetic fibers: laying long continuous glass strands wound into a reel onto a continuously moving support entails, in order to avoid any twisting of the strands, rotating the reel at right angles to its axis, and halting the movement at the end of each reel; by contrast, laying portions of glass strands onto the moving support is easy and can be performed completely uninterrupted.

The portions of glass strands, laid at random orientations, need to be in sufficient quantity that they form several thicknesses of strands and thus constitute a continuous mesh over the surface of the lap or molding reinforcement.

Such a continuous mesh also makes it easier to obtain good mechanical strength in the composite items that are subsequently produced by molding the molding reinforcement. It has been estimated that, under the same conditions, the mechanical strength conferred by a molding reinforcement with 20 cm glass strands according to the invention is 20% higher than the mechanical strength conferred by a molding reinforcement with glass strands 5 cm long.

According to another embodiment, the continuous glass strands are in the form of at least one expanded roving of long continuous glass strands, the roving coming from a reel or “roving”.

This arrangement in expanded rovings also encourages the elastic effect to give the internal layer a satisfactory thickness and an aerated nature to allow the resin to penetrate.

The roving of continuous glass strands may advantageously have a count of between around 2 400 and 4 800 tex.

The glass continuous strands may advantageously be formed of an assembly of filaments of individual diameter ranging between around 14 μm and around 17 μm.

As an alternative or in addition, the continuous glass strands may have an individual count of around 40 to 80 tex.

In order to improve the uniformity of the surface of the composite items produced by overmolding a molding reinforcement according to the invention, it is advantageously possible to provide, between the internal layer and at least one of the external layers, an intermediate layer based on chopped glass fibers.

According to an advantageous embodiment, the molding reinforcement according to the invention may have a grammage of between 400 and 1 800 g/m². This then is a good compromise between the thickness of the molding reinforcement and its ability to deform prior to molding.

According to another aspect, the invention provides a method of manufacturing such a molding reinforcement, comprising the steps of:

a) providing a first web of chemical fibers with hot melt surface,

b) laying continuous glass strands on the first web of chemical fibers with hot melt surface, all at random orientations and in several thicknesses, to form an internal layer of continuous glass strands,

c) laying a second web of chemical fibers with hot melt surface on the layer of continuous glass strands,

d) performing a double-sided light needling operation to cause portions of fibers with hot melt surface in each of the webs to penetrate the internal layer,

e) heating the whole assembly to a temperature high enough to soften the fibers with hot melt surface and make them sticky,

f) cold rolling the assembly.

According to a first possibility, during step b), the continuous glass strands are laid in the form of one or more expanded rovings of long continuous glass strands.

Preferably, during step b), the continuous glass strands are laid in the form of portions of glass strands in excess of around 20 cm in length.

### BRIEF DESCRIPTION OF THE DRAWINGS

Other objects, features and advantages of the present invention will emerge for the following description of particular embodiments, which is given in conjunction with the attached figures, among which:

FIG. 1 is a schematic view in longitudinal section of a molding reinforcement according to a first embodiment of the invention;

FIG. 2 is a schematic perspective view of a roving of continuous glass strands in the process of being expanded;

FIG. 3 is a perspective view of a continuous glass strand;

FIG. 4 is a schematic view in longitudinal section of the molding reinforcement in FIG. 1, during manufacture; and

FIG. 5 is a schematic view in longitudinal section of a molding reinforcement according to a second embodiment of the invention.

### DESCRIPTION OF PREFERRED EMBODIMENTS

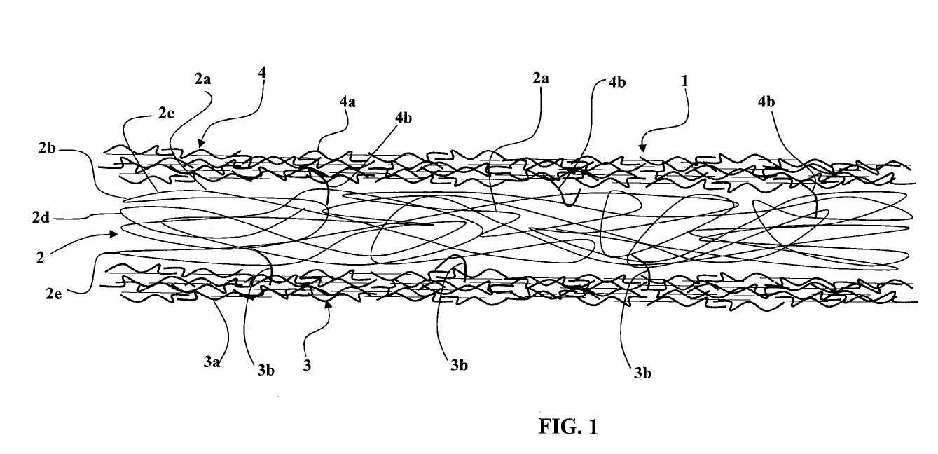

In a first embodiment illustrated in FIG. 1, a molding reinforcement 1 according to the invention comprises three layers of fibers, namely one internal layer 2 and two external layers 3 and 4 arranged on each side of the internal layer 2.

The internal layer 2 comprises continuous glass strands 2a which run at random orientations and in several thicknesses. That means that within the internal layer 2, the continuous glass strand 2a successively adopts all possible orientations in the overall plane of the internal layer 2, forming loops. The continuous glass strand 2a also rests on adjacent continuous glass strands in the internal layer 2, for example at several portions along its length. Because of the presence of loops, such as, for example in FIG. 1, the loops 2c, 2d and 2e, the points of contact run in several directions. The intermediate portions of continuous glass strands, between the points of contact, remain elastically flexible and give the internal layer 2 an aerated structure and the ability to be compressed elastically.

The external layers 3 and 4 each contain portions of fibers 3a and 4a with hot melt surface.

The portions of fibers 3a and 4a with hot melt surface may be made of any material that has a sufficiently low melting point and good properties of adhesion to the continuous glass strands 2a of the internal layer 2.

As an alternative, the portions 3a and 4a of fibers with hot melt surface may be two-component chemical fibers comprising a central core made of polyamide, polyester or polypropylene, and an external sheath made of copolyester, of polyethylene, or of any other material that has a melting point lower than that of the central core. Good results may be achieved using a central core made of polyester and an external sheath made of copolyester, or a central core made of polypropylene and an external sheath made of polyethylene. Other pairs of materials could be used in the form of coaxial two-component fibers: polypropylene and copolypropylene, polypropylene and ethyl vinyl acetate.

Because the central core of the two-component fiber has a higher melting point than the external sheath, the risk of accidentally completely melting the portions of fibers 3a and 4a with hot melt surface during manufacture of the molding reinforcement 1 is avoided.

The risk of the portions of hot melt fibers 3a and 4a, through excessive or uncontrolled heating during a step of heating to manufacture the molding insert 1, becoming completely melted, thereby forming uniform layers or layers that are impermeable to the resin through the spreading of their constituent material over the upper and lower faces of the reinforcing layer 2 is also effectively limited. The core of the two-component fibers is not impaired (or is impaired only very little) and the external layers 3 and 4 are thus maintained.

Further, the use of two-component fibers of hot melt surface with an external sheath and a central core means that the polyolefin content of the molding reinforcement 1 can be reduced. That is advantageous because the resin is not very compatible with polyolefins.

Of the portions 3a and 4a of fibers with hot melt surface in the external layers 3 and 4, at least some, for example the penetrating portions 3b and 4b in FIG. 1, over part of their length penetrate the internal layer 2 and adhere partially with one another and with the continuous glass strands 2a of the internal layer 2.

The penetrating portions 3b and 4b of fibers are uniformly distributed over the surface of the molding reinforcement 1 and provide the whole assembly with cohesion, while at the same time maintaining the deformability and flexibility properties of the molding reinforcement 1. The surface density of penetrating portions may be, for example, 5 to 10 portions per cm² of surface area of the molding reinforcement 1.

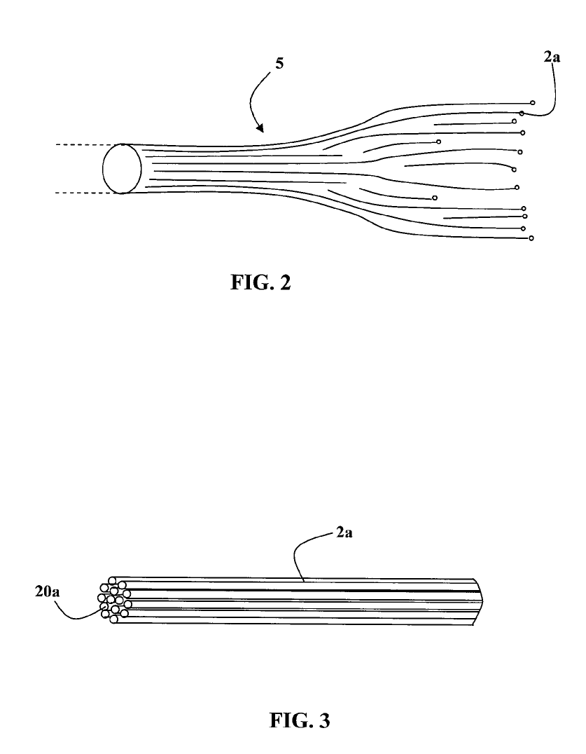

In practice, according to a first embodiment, in the internal layer 2, the continuous glass strands 2a may advantageously be distributed as at least one expanded roving of long continuous glass strands. By way of illustration, FIG. 2 depicts such a roving 5 or bundle of strands generally parallel to one another. Initially, in the roving, the continuous glass strands 2a are in contact with one another. As the roving 5 is expanded, the strands diverge from one another, while at the same time remaining in substantially parallel or not very divergent directions.

As an alternative, it may be preferable to form the internal layer 2 from an interlacing of portions of glass strand measuring at least around 20 cm long. Because of their interlacing and random orientations, the continuous glass strands form a continuous mesh on the surface of the molding reinforcement 1.

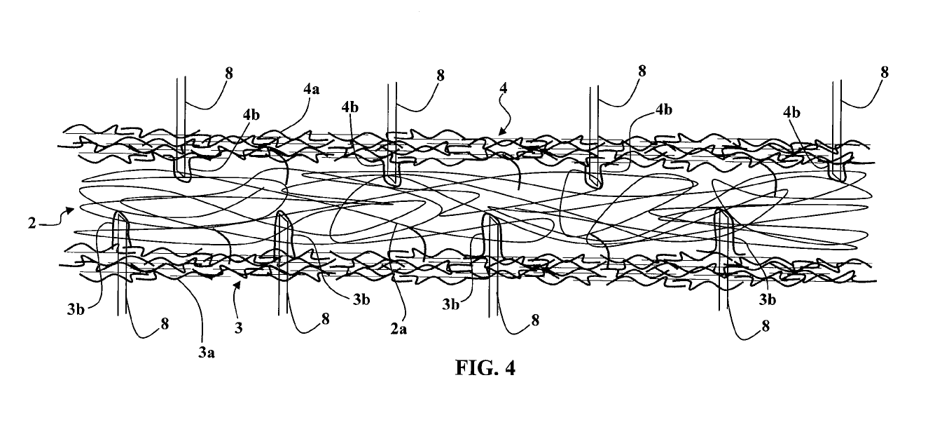

Continuous glass strands 2a (FIG. 3) formed of an assembly of filaments 20a, the individual diameter of which is between around 14 μm and around 17 μm, will advantageously be chosen. The individual count of the continuous glass strands may for example range between 40 and 80 tex, by assembling around 50 glass filaments.

The continuous glass strands 2a are in actual fact made up of enough filaments that they will not break during the handlings and uses according to the invention, it being pointed out that the individual filaments alone, at the size at which they usually leave the manufacturing dies, are too fragile to be handled and used in such a way.

The molding reinforcement 1 according to the invention can be produced in the form of a continuous strip that is packaged as a long reel.

For example, a first web of fibers with hot melt surface intended to constitute the external layer 3 is produced, portions of continuous glass strand 2a or one or more expanded rovings of continuous glass strands 2a are laid continuously on this first web 3, giving them a random orientation in order to produce an internal layer 2 with several thicknesses.

The operation of continuously laying the rovings of continuous glass strands 2a can be performed as described in document WO 98/42495 A1, except that the laying of the fibers is then done on the first web itself traveling on a continuous conveyor.

The operation of continuously laying portions of continuous glass strands 2a can be performed in the customarily known way used for portions of strands, by allowing them to fall randomly from the outlet of a chopping station.

A second web of fibers with hot melt surface intended to constitute the second external layer 4 is superposed on this internal layer 2 of continuous glass strands 2a thus produced.

The whole assembly thus obtained is subjected to a double-sided light needling operation which causes at least some (3b, 4b) of the portions of fibers 3a and 4a with a hot melt surface in each of the webs to penetrate the internal layer 2, the whole assembly is heated to a temperature high enough to soften the hot melt part of the fibers 3b, 4b with hot melt surface and to ensure that they adhere to the continuous glass strands 2a of the internal layer 2.

FIG. 4 schematically illustrates the light needling operation and shows the pre-needling needles 8, which drive penetrating portions 3b and 4b of fibers to cause them to penetrate the internal layer 2.

The light needling operation performed achieves, for example, a perforation density of around 5 to 10 perforations per cm². That should be compared against needling methods which, conventionally, achieve densities at least 10 times as high. The light needling operation allows a high throughput during manufacturing of the molding reinforcement according to the invention.

The light needling operation performed is enough to ensure that the rough molding reinforcement maintains sufficient cohesion while it is being transferred to the next work station, but is not enough to give the molding reinforcement 1 permanent cohesion and this reinforcement can still not be transported out of the needling machinery for use as a reinforcing product.

The heating operation carried out after the light needling operation softens the hot melt surface layer of the penetrating portions 3b, 4b of fibers in the external layers 3 and 4 to make them sticky. The penetrating portions 3b, 4b of fibers that have been driven in by the needles 8 of the light needling operation adhere to the continuous glass strands 2a of the internal layer 2. After cooling, the various layers 2, 3 and 4 of the molding reinforcement 1 are thus coupled together by the needled and bonded penetrating portions 3b, 4b of fibers. The molding reinforcement 1 is then cohesive and can be transported. The heating is regulated so as to soften the portions of fibers 3a, 4a with hot melt surface and make them sticky, but without melting them.

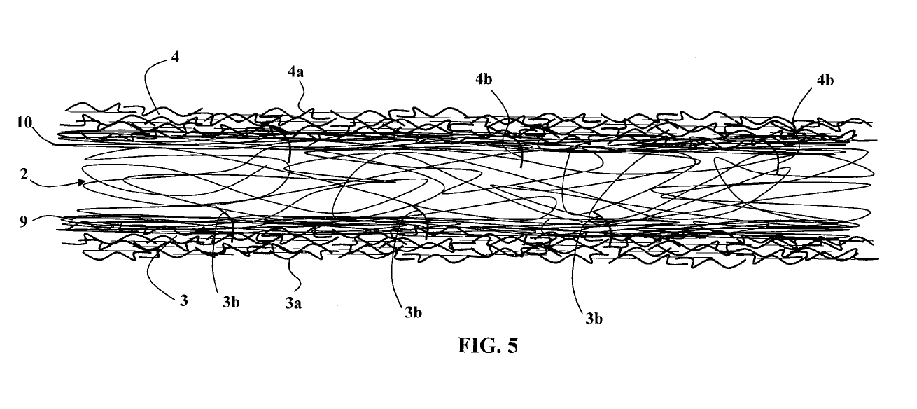

Consideration is now given to FIG. 5 which schematically illustrates a second embodiment of the molding reinforcement according to the invention.

This second embodiment differs from the first embodiment of FIG. 1 through the additional presence of two intermediate layers 9 and 10 between the internal layer 2 and the respective external layers 3 and 4. Each intermediate layer 9 or 10 is based on chopped glass fibers, distributed at random orientations generally parallel to the mean plane of the reinforcement.

These intermediate layers 9 and 10 have both the effect of providing mechanical reinforcement and the effect of smoothing the surface of the internal layer 2. This thus yields a molding reinforcement the surface of which is smoother, making it possible for the composite items produced by molding the molding reinforcement to have a good surface finish.

Again there are penetrating portions 3b, 4b of fibers which join the layers 2, 3, 4, 9 and 10 together.

### Example 1

I) a first web of chemical fibers with a hot melt surface is created on a conventional card. The portions of chemical fibers are made of two-component fibers with a polyester central core and hot melt external sheath made of copolyester. The hot melt external sheath made of copolyester has a melting point of around 110° C.

The two-component chemical fibers have an individual count of between around 2 denier and around 4 denier.

II) a second web of chemical fibers with hot melt surface, similar to the first web, is created on a conventional card.

III) one or more expanded rovings of continuous glass strands are laid on the first web of fibers with hot melt surface, giving them all random directions in several thicknesses. The continuous glass strands are formed of an assembly of 40 filaments having an individual diameter of around 15 μm, the strands having an individual count of around 50 tex.

IV) the second web is laid on the opposite side of the internal layer 2.

V) the rough molding reinforcement thus produced is introduced using a conveyer belt into a needling machine. The density of the needle perforations is 10/cm². The depth to which the needles penetrate is 12 mm. The rate of travel of the belt is 20 m/minute.

VI) After the light needling operation, the rough molding reinforcement is introduced into a through-air oven comprising a heating part 12 m long at a rate of travel of 20 m/minute. The temperature of the through-air oven is around 120° C.

VII) on leaving the through-air oven, the molding reinforcement 1 is cold-rolled to its final thickness of around 4 to 5 mm.

The grammage of the molding reinforcement 1 is 1 200 g/m².

The grammage can be between around 400 and 1 800 g/m².

### Example 2

A molding reinforcement is produced using the same steps as in example 1 above, with the only difference being that, in step III), it is portions of glass strands 20 cm long and with a count of 50 tex, each formed of 40 filaments having an individual diameter of around 15 μm that are laid on the first web of fibers with hot melt surface, in the same quantities as in example 1, in order to obtain the same grammage.

On completion of this step it is found that the thickness of the layer of glass strands is around 10 to 15 cm (before needling). This thickness is to be compared with the thickness of 3 or 4 cm that is obtained with an interlacing of portions of glass strands of the same diameter but 5 cm long. This demonstrates the elasticity and aeration effect conferred by the glass strands when their length exceeds around 20 cm.

The present invention is not restricted to the embodiments explicitly described but includes the various variations and generalizations thereof which are contained within the scope of the claims that follow.

1. A molding reinforcement made of a fiber-based lap, comprising:
a thick and aerated fiber-based internal layer (2),
external layers (3, 4) positioned on each side of the internal layer (2),
the external layers (3, 4) comprising portions of fibers (3a, 4a) with hot melt surface,
at least some (3b, 4b) of the portions (3a,4a) of fibers with hot melt surface penetrating the internal layer (2) over part of their length and adhering partially to one another and to the fibers of the internal layer (2),
wherein the internal layer (2) comprises fibers of the continuous glass strand type (2a) which run in random orientations and in several thicknesses.

2. A molding reinforcement as claimed in claim 1, wherein the continuous glass strands (2a) are portions of strands in excess of around 20 cm in length.

3. A molding reinforcement as claimed in claim 2, wherein, in the internal layer (2), the continuous glass strands (2a) form a continuous mesh along the surface of the lap.

4. A molding reinforcement as claimed in claim 1, wherein the continuous glass strands (2a) are in the form of at least one expanded roving (5) of long continuous glass strands.

5. A molding reinforcement as claimed in claim 4, wherein the roving (5) of continuous glass strands has a count of around 2 400 to 4 800 tex.

6. A molding reinforcement as claimed in claim 1, wherein the continuous glass strands (2a) are formed of an assembly of filaments of individual diameter ranging between around 14 μm and around 17 μm.

7. A molding MOWN reinforcement as claimed in claim 1, wherein the continuous glass strands (2a) have an individual count of around 40 to 80 tex.

8. A molding WON reinforcement as claimed in claim 1, further comprising, between the internal layer (2) and at least one of the external layers (3, 4), an intermediate layer (9, 10) based on chopped glass strands.

9. A molding reinforcement as claimed in claim 1, having a grammage of between 400 and 1 800 g/m².

10. A molding reinforcement as claimed in claim 1, being in the form of a continuous strip packaged in a reel.

11. A method of manufacturing a molding reinforcement as claimed in claim 1, comprising the steps of:
a) providing a first web (3) of chemical fibers with hot melt surface,
b) laying continuous glass strands on the first web (3) of chemical fibers with hot melt surface, all at random orientations and in several thicknesses, to form an internal layer (2) of continuous glass strands,
c) laying a second web (4) of chemical fibers with hot melt surface on the internal layer (2) of continuous glass strands,
d) performing a double-sided light needling operation to cause portions (3b, 4b) of fibers with hot melt surface in each of the webs (3, 4) to penetrate the internal layer (2),
e) heating the whole assembly to a temperature high enough to soften the fibers with hot melt surface and make them sticky,
f) cold rolling the assembly.

12. A method as claimed in claim 11, wherein, during step b), the continuous glass strands are laid in the form of one or more expanded rovings of long continuous glass strands.

13. A method as claimed in claim 11, wherein, during step b), the continuous glass strands are laid in the form of portions of glass strands whose length is greater than about 20 cm.
